(19) United States
(12) Patent Application Publication
(10) Pub. No.: US 2015/0010173 A1
(43) Pub. Date: Jan. 8, 2015

(54) APPARATUS AND METHOD FOR PROVIDING A FREQUENCY RESPONSE FOR AUDIO SIGNALS

(71) Applicant: QUALCOMM Incorporated, San Diego, CA (US)

(72) Inventors: Ricardo De Jesus Bernal Castillo, San Diego, CA (US); Andre Gustavo Pucci Schevciw, San Diego, CA (US)

(73) Assignee: QUALCOMM Incorporated, San Diego, CA (US)

(21) Appl. No.: 14/133,092

(22) Filed: Dec. 18, 2013

Related U.S. Application Data
(60) Provisional application No. 61/843,275, filed on Jul. 5, 2013.

(51) Int. Cl. H04R 17/00; H04R 1/02

(52) U.S. Cl. CPC H04R 17/00; H04R 1/028; H04R 2400/03; H04R 2499/11
USPC 381/162

(57) ABSTRACT

An apparatus includes a housing and a piezoelectric element coupled to the housing. The apparatus also includes an electromagnetic element coupled to the housing. The piezoelectric element is configured to convert first signals within a first frequency band into first sound waves by vibrating a first portion of the housing. The electromagnetic element is configured to convert second signals within a second frequency band into second sound waves by vibrating the first portion of the housing and a second portion of the housing.

### I. CLAIM OF PRIORITY

The present application claims priority from U.S. Provisional Application No. 61/843,275, filed Jul. 5, 2013, which is entitled “APPARATUS AND METHOD FOR PROVIDING A FREQUENCY RESPONSE FOR AUDIO SIGNALS,” the content of which is incorporated by reference in its entirety.

### II. FIELD

The present disclosure is generally related to providing a frequency response for audio signals.

### III. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and Internet protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player. Also, such wireless telephones can process executable instructions, including software applications, such as a web browser application, that can be used to access the Internet. As such, these wireless telephones can include significant computing capabilities.

Sound reproduction capabilities for portable computing devices may be limited. For example, wireless telephones may support audio signal reproduction for audio signals within a narrow acoustic frequency range. However, there is increasing demand to support audio signal reproduction for a wider range of acoustic frequencies. To illustrate, there is demand for wireless telephones to support audio signals within a Super Wideband frequency range (e.g., from approximately 50 hertz (Hz) to approximately 14 kilohertz (kHz)) and/or Ultrasound signals (e.g., signals ranging from approximately 20 kHz to above 60 kHz). Conventional earpieces of wireless telephones are not able to provide a high fidelity frequency response for each audio signal within the Super Wideband frequency range or for Ultrasound signals. For example, wireless telephones may include a moving mass transducer. The moving mass transducer may use a large diaphragm to reproduce sound at low frequencies. However, high frequency signals yield an irregular frequency response from the moving mass transducer (e.g., due to vibration of the diaphragm).

Conventional earpieces may also limit capabilities of wireless telephones in particular environments. For example, a conventional earpiece may include an acoustic port associated with a moving mass transducer to provide a frequency response to an audio signal. The acoustic port may subject internal circuitry of the wireless telephone to damage caused by water or other environmental factors.

### IV. SUMMARY

A method and an apparatus for a providing frequency response for audio signals are disclosed. An audio signal may include high frequency components within an upper frequency band and low frequency components within a lower frequency band. Filters (e.g., high-pass filters and low-pass filters) may separate the high frequency components and the low frequency components. The high frequency components of the audio signals may be amplified and provided to a first actuator (e.g., a piezoelectric element) coupled to a housing or a front-side glass of a mobile device, and the low frequency components may be amplified and provided to a second actuator (e.g., an electromagnetic element or a moving mass transducer) coupled to the housing or the front-side glass of the mobile device. The piezoelectric element may cause a first portion of the housing to vibrate in response to receiving the amplified high frequency components, and the electromagnetic element may cause a second portion of the housing to vibrate in response to receiving the amplified low frequency components. First sound waves may be generated in response to the vibration of the first portion of the housing by the piezoelectric element, and second sound waves may be generated in response to the vibration of the first and second portions of the housing by the electromagnetic element. A location (e.g., “sweet spot”) along the housing where the first sound waves intersect the second sound waves may provide enhanced audio quality (e.g., an enhanced quality of sound). For example, the location along the housing may provide a frequency response for audio signals covering an entire Super Wideband frequency range (e.g., from approximately 50 hertz (Hz) to 14 kilohertz (kHz)) and/or covering Ultrasound signals.

In a particular embodiment, an apparatus includes a housing and a piezoelectric element coupled to the housing. The apparatus also includes an electromagnetic element coupled to the housing. The piezoelectric element is configured to convert first signals within a first frequency band into first sound waves by vibrating a first portion of the housing. The electromagnetic element is configured to convert second signals within a second frequency band into second sound waves by vibrating the first portion of the housing and a second portion of the housing.

In another particular embodiment, a method includes driving a piezoelectric element coupled to a first portion of a housing using first signals within a first frequency band. The piezoelectric element converts the first signals into first sound waves by vibrating the first portion of the housing. The method also includes driving an electromagnetic element coupled to a second portion of the housing using second signals within a second frequency band. The electromagnetic element converts the second signals into second sound waves by vibrating the first portion of the housing and the second portion of the housing.

In another particular embodiment, a non-transitory computer readable medium includes instructions that, when executed by a processor, cause the processor to drive a piezoelectric element coupled to a first portion of a housing using first signals within a first frequency band. The piezoelectric element converts the first signals into first sound waves by vibrating the first portion of the housing. The instructions are also executable to cause the processor to drive an electromagnetic element coupled to a second portion of the housing using second signals within a second frequency band. The electromagnetic element converts the second signals into second sound waves by vibrating the first portion of the housing and the second portion of the housing.

In another particular embodiment, an apparatus includes a housing and means for converting first signals into first sound waves. The means for converting first signals into first sound waves includes a first actuator that vibrates a first portion of the housing in response to receiving the first signals. The first sound waves are generated in response to the first actuator vibrating the first portion of the housing. The apparatus also includes means for converting second signals into second sound waves. The means for converting second signals into second sound waves includes a second actuator that vibrates the first portion of the housing and a second portion of the housing in response to receiving the second signals. The second sound waves are generated in response to the second actuator vibrating the first portion of the housing and the second portion of the housing.

One particular advantage provided by at least one of the disclosed embodiments is an ability to provide a frequency response for audio signals within a Super Wideband frequency range (e.g., from approximately 50 hertz (Hz) to approximately 14 kilohertz (kHz)). Another advantage provided by at least one of the disclosed embodiments is an ability to generate sounds waves without an acoustic port in a housing, which may improve waterproofing techniques for handheld audio devices because there is no opening in the housing. Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a block diagram of a particular illustrative embodiment of a system that is operable to provide a frequency response for audio signals within an extended frequency range;

FIG. 2 is a diagram of an actuator of FIG. 1 coupled to a housing;

FIG. 3 is a diagram of vibrations corresponding to sound waves propagating along the housing of FIG. 2;

FIG. 4 is a flowchart of a particular embodiment of a method of providing a frequency response for audio signals within an extended frequency range; and

FIG. 5 is a block diagram of a wireless device including components operable to provide a frequency response for audio signals within an extended frequency range.

### VI. DETAILED DESCRIPTION

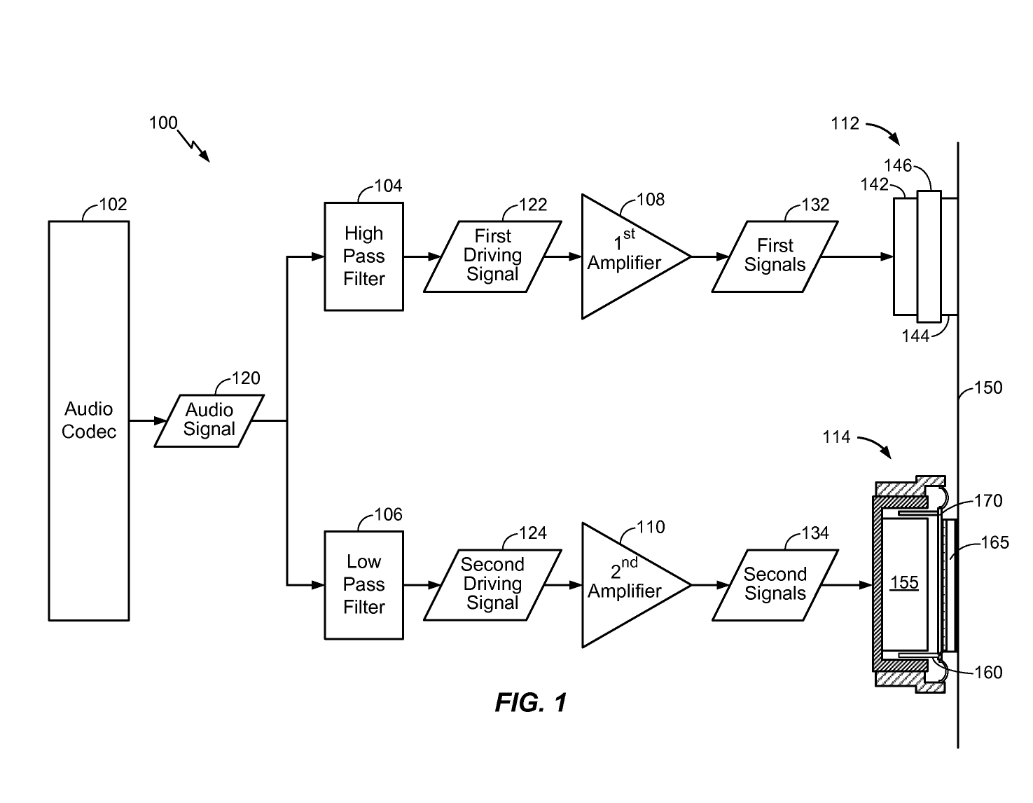

FIG. 1 illustrates a particular illustrative embodiment of a system 100 that is operable to provide a frequency response for audio signals within a particular frequency range. For example, the system 100 may provide a frequency response for audio signals within a Super Wideband frequency range (e.g., from approximately 50 hertz (Hz) to approximately 14 kilohertz (kHz)). The system 100 may include an audio encoder/decoder (CODEC) 102, a high pass filter 104, a low pass filter 106, a first amplifier 108, a second amplifier 110, a piezoelectric element 112, and an electromagnetic element 114.

The audio CODEC 102 may be configured to generate an audio signal 120. For example, the audio CODEC 102 may include a digital-to-analog converter and may decode a digital audio signal into the audio signal 120 (e.g., an analog audio signal). In a particular embodiment, the audio signal 120 may have frequency components within the Super Wideband frequency range or an Ultrasound range. As a non-limiting example, the audio signal 120 may have high frequency components ranging approximately from 1 kHz to 14 kHz, and the audio signal 120 may have low frequency components ranging approximately from 50 Hz to 1 kHz. The audio signal 120 may be provided to the high pass filter 104 and to the low pass filter 106.

The high pass filter 104 may be configured to receive the audio signal 120 and to generate a first driving signal 122 (e.g., a high frequency driving signal) by removing low frequency components of the audio signal 120. For example, the high pass filter 104 may provide high frequency components (e.g., components having a frequency above 1 kHz) of the audio signal 120 to the first amplifier 108, and the high pass filter 104 may block low frequency components of the audio signal 120. For example, the high pass filter 104 may reduce an amount of low frequency components of the audio signal 120 that are provided to the first amplifier 108. The low pass filter 106 may also be configured to receive the audio signal 120 and to generate a second driving signal 124 (e.g., a low frequency driving signal) by removing the high frequency components of the audio signal 120. For example, the low pass filter 106 may provide low frequency components (e.g., components having a frequency below 1 kHz) of the audio signal 120 to the second amplifier 110, and the low pass filter 106 may block high frequency components of the audio signal 120. For example, the low pass filter 106 may reduce an amount of high frequency components of the audio signal 120 that are provided to the second amplifier 110. Although, the “cut-off” frequencies of the high pass filter 104 and the low pass filter 106 are described with respect to a frequency of approximately 1 kHz, different frequencies may be used to improve the performance of the system 100. In a particular embodiment, the high pass filter 104 and the low pass filter 106 may have different “cut-off” frequencies. As a non-limiting example, the high pass filter 104 may block components of the audio signal 120 having a frequency below 1.4 kHz, and the low pass filter 106 may block components of the audio signal 120 having a frequency above 1.3 kHz.

The first amplifier 108 may be configured to receive the first driving signal 122 (e.g., the high frequency components of the audio signal 120) and to amplify the first driving signal 122 to generate an amplified first driving signal. The first amplifier 108 may provide first signals 132 to the piezoelectric element 112. The first signals 132 may include the amplified first driving signal. In a particular embodiment, the first signals 132 may have a frequency within a first frequency band. The first frequency band may range from approximately 1 kHz to 15 kHz.

The second amplifier 110 may be configured to receive the second driving signal 124 (e.g., the low frequency components of the audio signal 120) and to amplify the second driving signal 124 to generate an amplified second driving signal. The second amplifier 110 may provide second signals 134 to the electromagnetic element 114. The second signals 134 may include the amplified second driving signal. In a particular embodiment, the second signals 134 may have a frequency within a second frequency band. The second frequency band may range from approximately 50 Hz to 1 kHz.

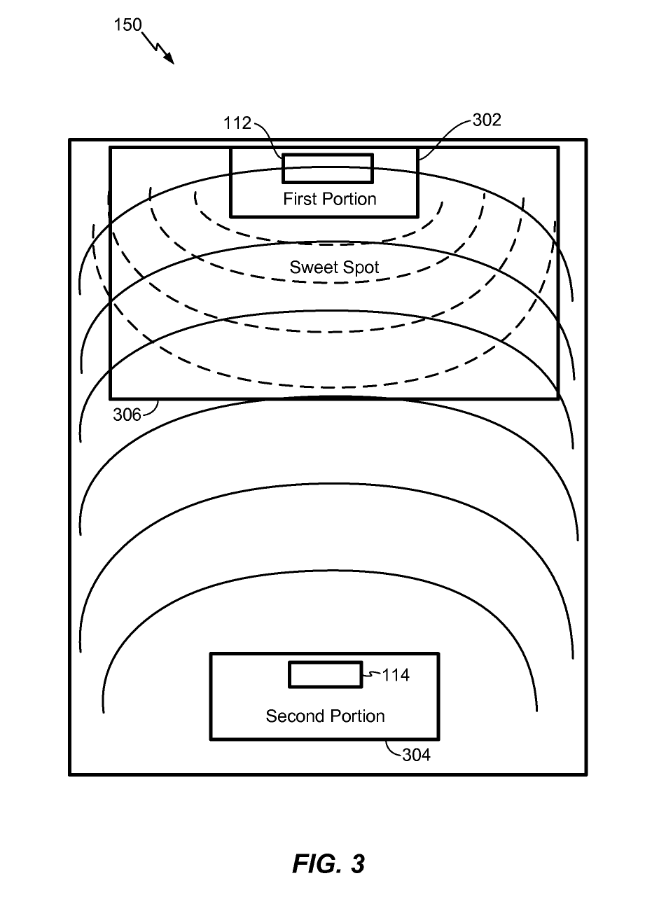

The piezoelectric element 112 may be configured to receive the first signals 132 and to convert the first signals 132 into first sound waves. The piezoelectric element 112 may be a first actuator configured to convert the first signals 132 into first sound waves by vibrating a first portion of a housing 150. For example, the piezoelectric element 112 may include, or be formed of, a piezoelectric material 146 that exhibits the piezoelectric effect. That is, in response to an electric field, the piezoelectric material 146 may change shape or external dimensions. The piezoelectric element 112 may also include a first electrode 142 coupled to a first side of the piezoelectric material 146 and a second electrode 144 coupled to a second side of the piezoelectric material 146. In a particular embodiment, the piezoelectric material 146 may include Berlinite, Quartz, Topaz, Barium Titanate, or any combination thereof. The first electrode 142 and/or the second electrode 144 may be coupled to receive the first signals 132 via an electrical contact. The first electrode 142 and the second electrode 144 may generate an electric field across the piezoelectric material 146 in response to receiving the first signals 132. The piezoelectric element 112 may change shape in response to the electric field. As described in further detail with respect to FIG. 3, first sound waves may be generated in response to vibrations of the piezoelectric material 146 coming into contact with the first portion of the housing 150.

The electromagnetic element 114 may be configured to receive the second signals 134 and to convert the second signals 134 into second sound waves. In a particular embodiment, the electromagnetic element 114 may be a moving mass transducer. The electromagnetic element 114 may be a second actuator configured to convert the second signals 134 into second sound waves by vibrating a second portion of the housing 150. For example, the electromagnetic element 114 may include a magnet 155, a coil 160 coupled to receive the second signals 134 via an electrical contact, and a first material 170 coupled to a second portion of the housing 150. A dampening member 165 may be coupled between the magnet 155 and the second portion of the housing 150. In a particular embodiment, the dampening member 165 may include an elastic polymer. The coil 160 may generate a magnetic field in response to receiving the second signals 134. Interaction of the magnetic field of the coil 160 and a magnetic field of the magnet 155 may cause the magnet 155 to move relative to the housing 150. Movement of the magnet 155 may induce the production of vibrations at the second portion of the housing 150. The vibrations based on the movement of the magnet may propagate to the first portion of the housing 150 (e.g., propagate along the entire housing 150).

In a particular embodiment, the piezoelectric element 112 and the electromagnetic element 114 may be mounted (e.g., positioned) on a front-side glass of a mobile device. For example, the front-side glass may be a portion of or attached to the housing 150 of the mobile device. In a particular embodiment, the housing 150 may be associated with an earpiece of a handheld audio device. For example, the housing 150 may be an outer-casing of an earpiece and may not include an acoustic port.

The system 100 may generate sound waves over a Super Wideband frequency range and/or an Ultrasound range by using a two-amplifier configuration to drive frequency components within an upper frequency band with the piezoelectric element 112 and to drive frequency components within a lower frequency band with the electromagnetic element 114. For example, the system 100 may convert the high frequency components of the audio signal 120 into the first sound waves (e.g., high frequency waves) by vibrating the first portion of the housing 150 with the piezoelectric element 112. In addition, the system 100 may convert the low frequency components of the audio signal 120 into second sound waves (e.g., low frequency waves) by vibrating the second portion of the housing 150 with the electromagnetic element 114. Since the first and second sound waves are produced by vibration induced in the housing 150, no acoustic port is needed in the housing 150.

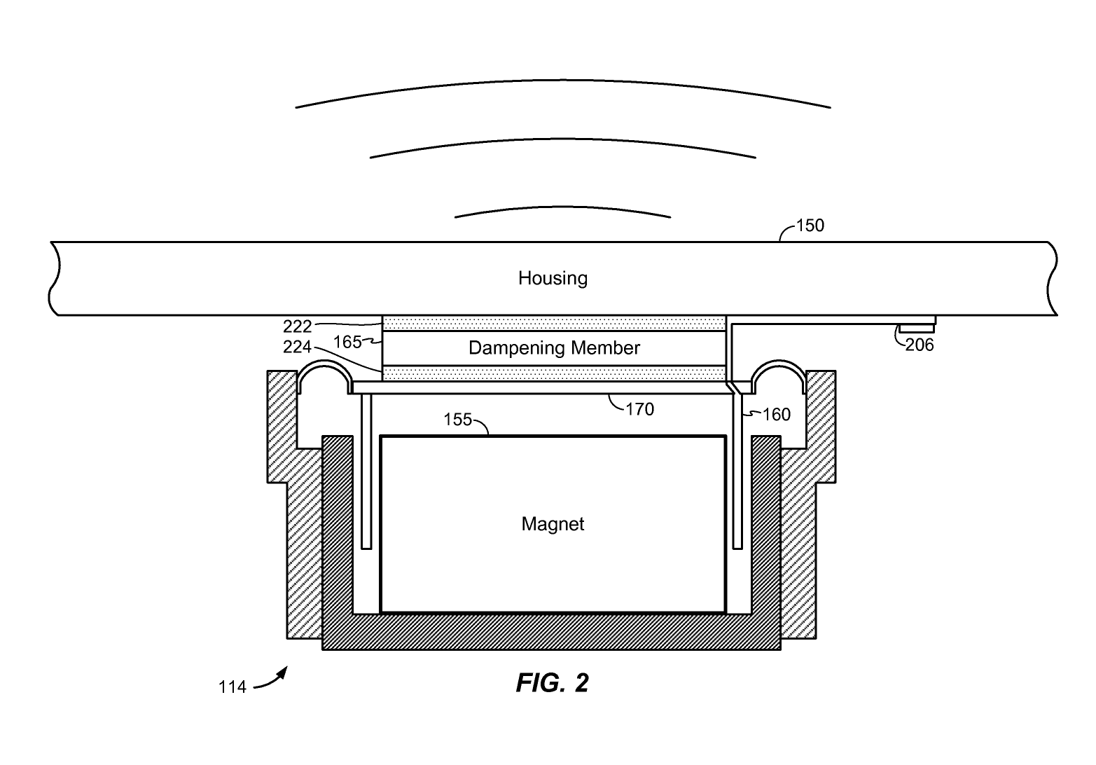

Referring to FIG. 2, a diagram of the electromagnetic element 114 coupled to the housing 150 is shown. In a particular embodiment, the housing 150 may include a glass portion and/or a plastic portion. The electromagnetic element 114 may be coupled to the glass portion and/or the plastic portion of the housing 150. Also, the piezoelectric element 112 of FIG. 1 may be coupled to the housing 150 at another location (not shown in FIG. 2).

The electromagnetic element 114 may include the magnet 155, the first material 170, the coil 160, and the dampening member 165. The coil 160 may be coupled to receive the second signals 134 via an electrical contact 206. The coil 160 may generate a magnetic field in response to receiving the second signals 134. The magnet 155 may move (e.g., vibrate) in response to an interaction of the magnetic field of the coil 160 and the magnetic field of the magnet 155. The electrical contact(s) 206 may be positioned along the housing 150 (e.g., at a front-side of the electromagnetic element 114) to permit a backside of the electromagnetic element 114 (and the magnet 155) to move.

The first material 170 may be coupled to the housing 150 via an adhesive. For example, a first adhesive 222 may be coupled to a first side of the dampening member 165 and to the housing 150. A second adhesive 224 may be coupled to a second side of the dampening member 165 and to the first material 170. The dampening member 165 may include an elastic polymer.

During operation, the electrical contact 206 may provide the second signals 134 to the coil 160. In response to receiving the second signals 134, the coil 160 may generate a magnetic field that causes the magnet 155 to move (e.g., toward the housing 150 or away from the housing 150). The movements of the magnet 155 cause vibration of the housing 150. Vibrations of the housing 150 may generate the second sound waves (e.g., low frequency waves). Because the vibrations of the housing 150 are used to produce the second sound waves, no acoustic port is needed in the housing 150.

Referring to FIG. 3, a diagram of vibrations that correspond to sound waves propagating along the housing 150 is shown. The housing 150 may include a first portion 302 and a second portion 304. In a particular embodiment, the first portion 302 and the second portion 304 of the housing 150 may each correspond to a glass portion of the housing 150, such as a display screen of a portable computing device. In another particular embodiment, the first portion 302 and the second portion 304 of the housing 150 may each correspond to a plastic portion of the housing 150. In another particular embodiment, the housing 150 includes a front-side glass of a mobile device.

The piezoelectric element 112 of FIG. 1 may be coupled to the first portion 302 of the housing 150 to generate first vibrations corresponding to the first sound waves (e.g., high frequency waves), illustrated as dashed lines. The electromagnetic element 114 of FIG. 1 may be coupled to the second portion 304 of the housing 150 to generate second vibrations corresponding to the second sound waves (e.g., low frequency waves), illustrated as solid lines. The first vibrations have a relatively high loss. However, the second vibrations have a relatively low loss, enabling the second vibrations to intersect the first vibrations at a “sweet spot” 306. The sweet spot 306 may correspond to a particular location where a quality of sound is enhanced by the first vibrations intersecting the second vibrations. For example, the sweet spot 306 may correspond to a location along the housing 150 where the high frequency components of the audio signal 120 of FIG. 1 and the low frequency components of the audio signal 120 are reproduced in a relatively clear manner.

In a particular embodiment, the housing 150, the piezoelectric element 112, and the electromagnetic element 114 may be integrated into a handheld device. For example, the housing 150, the piezoelectric element 112, and the electromagnetic element 114 may be integrated into a portable (e.g., wireless) telephone. In this example, the housing 150 may correspond to the outer casing (including front-side glass) of the portable telephone. The piezoelectric element 112 and the electromagnetic element 114 may be coupled to the housing 150 at selective locations (e.g., the first portion 302 and the second portion 304).

Because the second vibrations may travel along the entire housing 150, in a particular embodiment, the electromagnetic element 114 and the piezoelectric element 112 may be coupled to the housing at multiple different locations without compromising an enhanced quality of sound that corresponds to the sweet spot 306. For example, the electromagnetic element 114 may be coupled to a front side of the housing 150 and the piezoelectric element 112 may be coupled to a backside of the housing 150. The sweet spot 306 may form wherever the second vibrations intersect the first vibrations based on placement of the piezoelectric element 112 and the electromagnetic element 114.

The sweet spot 306 may replace a conventional acoustic port by generating sound waves that are audible to a user over a relatively large area of the housing 150. For example, the sweet spot 306 may provide a relatively large area on the housing 150 where audio quality is enhanced as compared to a relatively small area (e.g., a few millimeters) associated with the conventional acoustic port. The user may hear sound along each location of the housing 150 that vibrates in response to the piezoelectric element 112 or the electromagnetic element 114; however, the vibrations located at the sweet spot 306 may produce sound waves based on both the piezoelectric element 112 and the electromagnetic element 114. Thus, the sound waves produced at the sweet spot 306 may be associated with both high frequency components of the audio signal 120 and low frequency components of the audio signal 120. Replacing the conventional acoustic port with the sweet spot 306 may improve waterproofing for handheld audio devices because there is no opening in the housing 150 to output sound. Thus, embodiments disclosed herein may reduce the likelihood of internal circuitry of the portable telephone being damaged by water or other environmental factors.

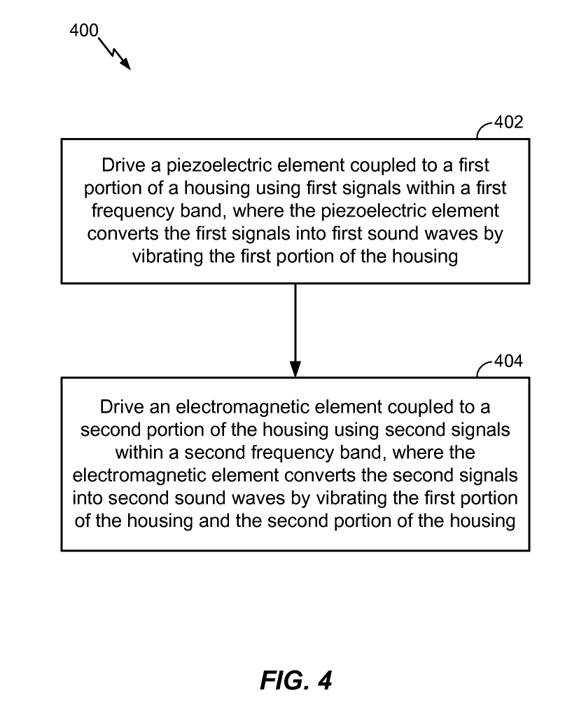

Referring to FIG. 4, a particular embodiment of a method 400 of providing a frequency response for audio signals within an extended frequency range is shown. The method 400 may be performed by the system 100 of FIG. 1 with respect to the housing 150 illustrated in FIGS. 2-3. The sequence of steps in FIG. 4 is only for illustration purpose. Those of skill would further appreciate that each block 402, 404 may be executed in reverse order or concurrently.

The method 400 includes driving a piezoelectric element coupled to a first portion of a housing using first signals within a first frequency band, at 402. For example, the first amplifier 108 may amplify the first driving signal 122 (e.g., amplify the high frequency components of the audio signal 120) to generate the amplified first driving signal. The first amplifier 108 may provide the first signals 132 (e.g., the amplified first driving signal) to the electrodes 142, 144 of the piezoelectric element 112 via the electrical contact. In response to receiving the first signals 132, the piezoelectric element 112 may change shape and induce vibration (e.g., the first vibration) at the first portion 304 of the housing 150. The vibration of the housing 150 may produce first sound waves corresponding to the first signals 132.

An electromagnetic element coupled to a second portion of the housing may be driven using second signals within a second frequency band, at 404. For example, the second amplifier 110 may amplify the second driving signal 124 (e.g., amplify the low frequency components of the audio signal 120) to generate the amplified second driving signal. The second amplifier 110 may provide second signals 134 (e.g., the amplified second driving signal) to the coil 160 of the electromagnetic element 114 via the electrical contact 206. The coil 160 may generate a magnetic field in response to receiving the second signals 134. Interaction of the magnetic field of the coil 160 and a magnetic field of the magnet 155 may cause movement of the magnet 155 relative to the housing 150. The relative movement of the magnet 155 and the housing 150 may induce second vibrations at the first portion 302 of the housing 150 and at the second portion 304 of the housing 150. The second vibrations of the housing 150 may produce second sound waves correspond to the second signals 134.

In a particular embodiment, the method 400 may include receiving an audio signal. For example, the high pass filter 104 may receive the audio signal 120 from the audio CODEC 102, and the low pass filter 106 may also receive the audio signal 120 from the audio CODEC 102.

In a particular embodiment, the method 400 may include generating the first signals within the first frequency band. For example, the high pass filter 104 may pass high frequency components (e.g., components having a frequency above 1 kHz) of the audio signal 120 to generate the first driving signal 122, and the high pass filter 104 may block low frequency components of the audio signal 120. The first driving signal 122 may be amplified by the first amplifier 108 to generate the first signals 132.

In a particular embodiment, the method 400 may include generating the second signals within the second frequency band. For example, the low pass filter 106 may pass low frequency components (e.g., components having a frequency below 1 kHz) of the audio signal 120 to generate the second driving signal 124, and the low pass filter 106 may block high frequency components of the audio signal 120. The second driving signal 124 may be amplified by the second amplifier 110 to generate the second signals 134. The first frequency band may be higher than the second frequency band. For example, in a particular embodiment, the first frequency band may range from approximately 1 kHz to 60 kHz and the second frequency band may range from approximately 50 Hz to 1 kHz.

The method 400 of FIG. 4 may generate sound waves over a Super Wideband frequency range by using a two-amplifier configuration to drive frequency components within an upper frequency band with the piezoelectric element 112 and to drive frequency components within a lower frequency band with the electromagnetic element 114. For example, high frequency components of the audio signal 120 may be converted into the first sound waves (e.g., high frequency waves) by vibrating the first portion 302 of the housing 150 with the piezoelectric element 112. In addition, low frequency components of the audio signal 120 may be converted into second sound waves (e.g., low frequency waves) by vibrating the second portion 304 of the housing 150 with the electromagnetic element 114.

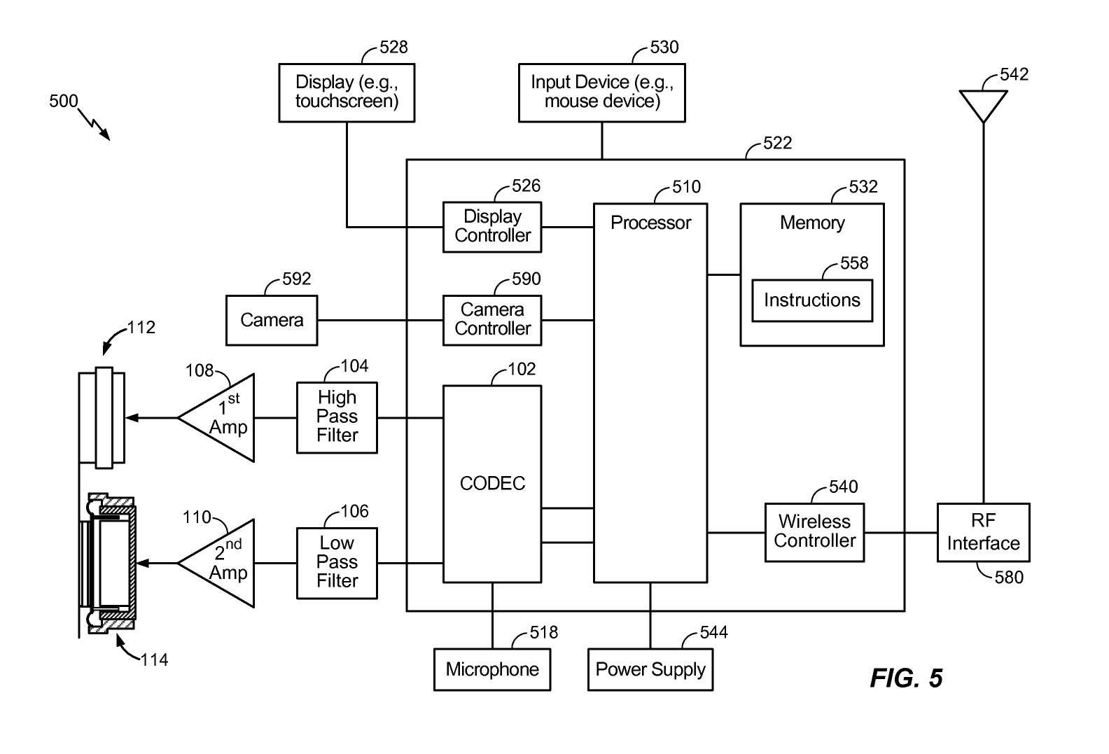

Referring to FIG. 5, a block diagram of a wireless device 500 including components operable to provide a frequency response for audio signals within an extended frequency range is shown. The device 500 includes a processor 510, such as a digital signal processor (DSP), coupled to a memory 532.

FIG. 5 also shows a display controller 526 that is coupled to the processor 510 and to a display 528. A camera controller 590 may be coupled to the processor 510 and to a camera 592. The device 500 may include the system 100 of FIG. 1. For example, the device 500 includes the audio CODEC 102 of FIG. 1 coupled to the processor 510. The device 500 also includes the high pass filter 104 of FIG. 1, the low pass filter 106 of FIG. 1, the first amplifier 108 of FIG. 1, the second amplifier 110 of FIG. 1, the piezoelectric element 112 of FIG. 1, and the electromagnetic element 114 of FIG. 1. The piezoelectric element 112 may be coupled to the first portion of the housing, and the electromagnetic element 114 may be coupled to the second portion of the housing. Thus, the piezoelectric element 112 and the electromagnetic element 114 may generate sound waves responsive to signals provided to the CODEC 102 by the processor 510. The signals may include voice call signals, streaming media signals received via an antenna 542, audio file playback signals, etc. The device 500 also includes a microphone 518 coupled to the audio CODEC 102.

The memory 532 may be a tangible non-transitory processor-readable storage medium that includes instructions 558. The instructions 558 may be executed by a processor, such as the processor 510 or the components thereof, to perform the method 400 of FIG. 4. FIG. 5 also indicates that a wireless controller 540 can be coupled to the processor 510 and to the antenna 542 via a radio frequency (RF) interface 580. In a particular embodiment, the processor 510, the display controller 526, the memory 532, the CODEC 508, the wireless controller 540, and the RF interface 580 are included in a system-in-package or system-on-chip device 522. In a particular embodiment, an input device 530 and a power supply 544 are coupled to the system-on-chip device 522. Moreover, in a particular embodiment, as illustrated in FIG. 5, the display 528, the input device 530, the microphone 518, the antenna 542, the high pass filter 104, the low pass filter 106, the first amplifier 108, the second amplifier 110, the piezoelectric element 112, the electromagnetic element 114, and the power supply 544 are external to the system-on-chip device 522. However, each of the display 528, the input device 530, the microphone 518, the antenna 542, the high pass filter 104, the low pass filter 106, the first amplifier 108, the second amplifier 110, the piezoelectric element 112, the electromagnetic element 114, the RF interface 580, and the power supply 544 can be coupled to a component of the system-on-chip device 522, such as an interface or a controller.

In conjunction with the described embodiments, a first apparatus is disclosed that includes a housing (e.g., the housing 150 of FIG. 1) and means for converting first signals into first sound waves. The means for converting first signals into first sound waves includes a first actuator that vibrates a first portion of the housing in response to receiving the first signals. The first sound waves are generated in response to the first actuator vibrating the first portion of the housing. The means for converting first signals into first sound waves may include the piezoelectric element 112 of FIG. 1, the housing 150 of FIG. 1, the first portion 302 of the housing 150 of FIG. 3, one or more other devices, circuits, or modules to convert first signals into first sound waves, or any combination thereof.

The first apparatus may also include means for converting second signals into second sound waves. The means for converting second signals into second sound waves includes a second actuator that vibrates the first portion of the housing and a second portion of the housing in response to receiving the second signals. The second sound waves are generated in response to the second actuator vibrating the first portion of the housing and the second portion of the housing. The means for converting the second signals into second sound waves may include the electromagnetic element 114 of FIGS. 1-2 and the components thereof, the housing 150 of FIG. 1, the second portion 304 of the housing 150 of FIG. 3, one or more other devices, circuits, or modules to convert second signals into second sound waves, or any combination thereof.

In conjunction with the described embodiments, a second apparatus is disclosed that includes means for receiving an audio signal. For example, the means for receiving the audio signal may include the CODEC 102 of FIG. 1, the high pass filter 104 of FIG. 1, the low pass filter 106 of FIG. 1, the first amplifier 108 of FIG. 1, the second amplifier 110 of FIG. 1, the processor 510 programmed to execute the instructions 558 of FIG. 5, one or more other devices, circuits, or modules to receive the audio signal, or any combination thereof.

The second apparatus may also include means for generating first signals within a first frequency band. For example, the means for generating the first signals may include the high pass filter 104 of FIG. 1, the first amplifier 108 of FIG. 1, the processor 510 programmed to execute the instructions 558 of FIG. 5, one or more other devices, circuits, or modules to generate the first signals, or any combination thereof.

The second apparatus may also include means for generating second signals within a second frequency band. For example, the means for generating the second signals may include the low pass filter 106 of FIG. 1, the second amplifier 110 of FIG. 1, the processor 510 programmed to execute the instructions 558 of FIG. 5, one or more other devices, circuits, or modules to filter the generate the second signals, or any combination thereof.

The second apparatus may also include means for generating first sound waves based on the first signals. For example, the means for generating the first sound waves may include the piezoelectric element 112 of FIG. 1, the piezoelectric material 146 of FIG. 1, the housing 150 of FIG. 1, one or more other devices, circuits, or modules to generate the first sound waves, or any combination thereof.

The second apparatus may also include means for generating second sound waves based on the second signals. For example, the means for generating the second sound waves may include the electromagnetic element 114 of FIG. 1, the magnet 155 of FIG. 1, the dampening member 165 of FIG. 1, the first material 170 of FIG. 1, the coil 160 of FIG. 1 the housing 150 of FIG. 1, one or more other devices, circuits, or modules to generate the second sound waves, or any combination thereof.

Those of skill would further appreciate that the various illustrative logical blocks, configurations, modules, circuits, and algorithm steps described in connection with the embodiments disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. An apparatus comprising:
a housing;
a piezoelectric element coupled to the housing; and
an electromagnetic element coupled to the housing;
wherein the piezoelectric element is configured to convert first signals within a first frequency band into first sound waves by vibrating a first portion of the housing, and wherein the electromagnetic element is configured to convert second signals within a second frequency band into second sound waves by vibrating the first portion of the housing and a second portion of the housing.

2. The apparatus of claim 1, wherein the piezoelectric element is a first actuator, and wherein the electromagnetic element is a second actuator.

3. The apparatus of claim 1, wherein the housing does not comprise an acoustic port.

4. The apparatus of claim 1, wherein the housing is associated with an earpiece of a handheld audio device.

5. The apparatus of claim 1, wherein a quality of sound is enhanced at a location where first vibrations corresponding to the first sound waves intersect second vibrations corresponding to the second sound waves.

6. The apparatus of claim 1, wherein the housing comprises a glass portion, and wherein the first portion of the housing, the second portion of the housing, or both, is part of the glass portion.

7. The apparatus of claim 1, wherein the housing comprises a plastic portion, and wherein the first portion of the housing, the second portion of the housing, or both, is part of the plastic portion.

8. The apparatus of claim 1, wherein the housing, the piezoelectric element, and the electromagnetic element are integrated into a handheld audio device.

9. The apparatus of claim 8, wherein the handheld audio device comprises a portable phone.

10. The apparatus of claim 1, wherein the housing comprises a front-side glass portion of a mobile device.

11. The apparatus of claim 1, wherein the piezoelectric element comprises:
a piezoelectric material;
a first electrode coupled to a first side of the piezoelectric material; and
a second electrode coupled to a second side of the piezoelectric material;
wherein the first electrode and the second electrode are coupled to receive the first signals via an electrical contact.

12. The apparatus of claim 11, wherein the first electrode and the second electrode generate an electric field across the piezoelectric material in response to receiving the first signals, wherein the piezoelectric material changes shape in response to the electric field, and wherein the first sound waves are generated in response to vibrations of the piezoelectric material in contact with the first portion of the housing.

13. The apparatus of claim 1, wherein the electromagnetic element is a moving mass transducer.

14. The apparatus of claim 1, wherein the electromagnetic element comprises:
a magnet;
a coil coupled to receive the second signals via an electrical contact; and
a first material coupled to the second portion of the housing;
wherein the coil generates a magnetic field in response to receiving the second signals, wherein the magnet moves in response to the magnetic field, and wherein the second sound waves are generated in response to movement of the magnet.

15. The apparatus of claim 14, wherein the first material is coupled to the second portion of the housing via an adhesive.

16. The apparatus of claim 14, further comprising a dampening member coupled between the magnet and the second portion of the housing.

17. The apparatus of claim 16, wherein the dampening member comprises an elastic polymer.

18. The apparatus of claim 1, further comprising:
a high pass filter configured to pass high frequency components of an audio signal to generate a high frequency driving signal; and
a low pass filter configured to pass low frequency components of the audio signal to generate a low frequency driving signal.

19. The apparatus of claim 18, further comprising:
a first amplifier configured to amplify the high frequency driving signal, wherein the first signals comprise the amplified high frequency driving signal; and
a second amplifier configured to amplify the low frequency driving signal, wherein the second signals comprise the amplified low frequency driving signal.

20. The apparatus of claim 1, wherein the first frequency band is higher than the second frequency band.

21. The apparatus of claim 1, wherein a first frequency within the first frequency band is between approximately one kilohertz (kHz) and sixty kHz.

22. The apparatus of claim 1, wherein a second frequency within the second frequency band is between approximately fifty hertz (Hz) and one kilohertz (kHz).

23. A method comprising:
driving a piezoelectric element coupled to a first portion of a housing using first signals within a first frequency band, wherein the piezoelectric element converts the first signals into first sound waves by vibrating the first portion of the housing; and
driving an electromagnetic element coupled to a second portion of the housing using second signals within a second frequency band, wherein the electromagnetic element converts the second signals into second sound waves by vibrating the first portion of the housing and the second portion of the housing.

24. The method of claim 23, wherein the piezoelectric element is a first actuator, and wherein the electromagnetic element is a second actuator.

25. The method of claim 23, wherein the housing does not comprise an acoustic port.

26. The method of claim 23, wherein the housing is associated with an earpiece of a handheld audio device.

27. The method of claim 23, wherein a quality of sound is enhanced at a location where first vibrations corresponding to the first sound waves intersect second vibrations corresponding to the second sound waves.

28. An apparatus comprising:
a housing;
means for converting first signals into first sound waves, wherein the means for converting first signals into first sound waves comprises a first actuator that vibrates a first portion of the housing in response to receiving the first signals, and wherein the first sound waves are generated in response to the first actuator vibrating the first portion of the housing; and
means for converting second signals into second sound waves, wherein the means for converting second signals into second sound waves comprises a second actuator that vibrates the first portion of the housing and a second portion of the housing in response to receiving the second signals, and wherein the second sound waves are generated in response to the second actuator vibrating the first portion of the housing and the second portion of the housing.
